(19) United States
(12) Patent Application Publication
(10) Pub. No.: US 2011/0187851 A1
(43) Pub. Date: Aug. 4, 2011

(54) CHASSIS-MEASURING SYSTEM AS WELL AS METHOD FOR DETERMINING THE POSITION PARAMETERS OF MEASURING HEADS OF A CHASSIS-MEASURING SYSTEM

(76) Inventors: Guenter Nobis, Nuertingen (DE); Steffen Abraham, Hildesheim (DE); Daniel Muhle, Herford (DE); Volker Uffenkamp, Ludwigsburg (DE)

(21) Appl. No.: 12/736,013

(22) PCT Filed: Feb. 2, 2009
(86) PCT No.: PCT/EP2009/051114

§ 371 Date: Nov. 16, 2010

(30) Foreign Application Priority Data
Mar. 26, 2008 (DE) 10 2008 000 837.0

(51) Int. Cl. H04N 7/18

(52) U.S. Cl. 348/135; 348/E07.085

(57) ABSTRACT

A chassis measuring system according to the invention includes at least one pair of first and second measuring heads (2, 21), which are situated diametrically opposed in the transverse vehicle direction, each measuring head (2, 21) having at least one measuring camera (4, 8; 14, 18) and an illumination device (6, 10; 16, 20) pointing in the same direction as the measuring camera (4, 8; 14, 18), as well as a data processing unit, which is connected to the measuring heads (2, 12) and designed in such a way that it determines the position parameters of the measuring heads (2, 12) relative to each other by comparing the image of the illumination device (16, 20) of the second measuring head (12) recorded by the measuring camera (4, 8) of the first measuring head (2) with stored reference images.

### BACKGROUND OF THE INVENTION

1. Field of the Invention

The present invention relates to a chassis measuring system having at least one pair of measuring heads situated opposite each other in the transverse vehicle direction, and to a method for determining the position parameters of measuring heads of a chassis measuring system.

2. Description of Related Art

An optical contactless chassis measurement, e.g. the measurement of the track and camber in motor vehicles, uses measuring heads having measuring cameras, which respectively detect one wheel of the motor vehicle or a target attached to it. The position of wheel axles, axes of rotation, wheel centers or centers of rotation can be calculated from the measuring values, and the values of track and camber of the motor vehicle are able to be determined on this basis.

A basic prerequisite of a contactless chassis measuring system is that the geometric position parameters of the measuring heads relative to each other are known, particularly their distance and orientation, and that the measuring values of all measuring heads are represented in a common coordinate system or reference system or are transformed into such a common coordinate system. It is known from published German patent document DE 3618480 that the measuring heads measure points on a ground control point element. Using the measurement of the ground control points in the local reference system of the individual measuring heads and the known coordinates of the ground control points, it is possible to transform the local coordinate system of each measuring head into the common global coordinate system. This method requires the presence of a ground control point element, which entails additional effort and additional expense.

Therefore, it is the objective of the present invention to provide a chassis measuring system and a method for determining the position parameters of measuring heads of a chassis measuring system, in which the position parameters of the measuring heads may be determined simply, quickly and cost-effectively.

### SUMMARY OF THE INVENTION

These and other objects of the invention are achieved by a chassis measuring system, comprising at least one pair of first and second measuring heads (2, 21), which are situated diametrically opposed in the transverse vehicle direction, each measuring head (2, 21) having at least one measuring camera (4, 8; 14, 18) and an illumination device (6, 10; 16, 20) pointing in the same direction as the measuring camera (4, 8; 14, 18), a data processing unit which is connected to the measuring heads (2, 12) and designed in such a way that it determines the position parameters of the measuring heads (2, 12) relative to each other by comparing the image of the illumination device (16, 20) of the second measuring head (12) recorded by the measuring camera (4, 8) of the first measuring head (2), with stored reference images.

According to the present invention, the term chassis measurement is understood as a generic term for an axle measurement and for other applications such as dynamic shock absorber testing, for example. According to the present invention, the term measuring cameras encompasses all optical detection devices that are used in the contactless chassis measurement, in particular video cameras and video sensors.

According to a basic idea of the present invention, the geometric position parameters of the measuring heads may be determined in a simple manner and the measuring data received from the measuring heads may therefore be represented in a common coordinate system without requiring additional markings on the measuring station or on the measuring head, or even ground control point elements. The costs of such additional markings or ground control point elements required in methods according to the related art may be saved according to the present invention. Determining the position parameters of the measuring heads according to the present invention makes it possible to check and possibly restore the geometric position parameters at any given time and in a simple manner. If a deviation from the premised setpoint values is ascertained in the positioning of the measuring heads, in particular in their distance and orientation, then the measuring heads may be suitably shifted or rotated on the one hand, such that an agreement is achieved between the actual position parameters and the predefined position parameters, and the changed position parameters may be included in the calculation of the transformation of the local coordinate systems into the global coordinate system on the other hand, such that the adjustment of the position parameters and the restoration of the common global coordinate system are achieved purely computationally.

The method according to the present invention may be used both for determining the orientation of the measuring heads prior to the actual measurement as well as for checking and adjusting the orientation during the measurement.

When determining the orientation prior to the measurement, the measuring heads are first completely aligned with each other, without a motor vehicle standing on the measuring station, in such a way that the illumination devices lie within the visual field of the measuring camera of the individual measuring head lying diametrically opposed. Then it is possible to precisely determine the position parameters of the measuring heads using the method according to the present invention.

Checking and adjusting the orientation of the measuring heads during the measurement takes place in particular in flexible axle measuring systems in which the measuring heads are mobile and may be moved during the measurement, for example, so as to be able to measure motor vehicles having different wheel bases. The method according to the present invention makes it possible to detect and possibly adjust the movement or shifting of the measuring head.

If the illumination device and the measuring cameras are installed so as to allow for reciprocal monitoring below or above the vehicle, then the method according to the present invention may be used not only on an empty measuring station, but also on a measuring station having a vehicle located on it.

In a simple variant, the chassis measuring system according to the present invention and the method for determining the position parameters according to the present invention include a pair of measuring heads situated opposite each other in the transverse vehicle direction.

In one development featuring four measuring heads, which are situated diametrically opposed to a wheel of a motor vehicle, it is possible to establish also a longitudinal connection for at least one pair of measuring heads lying diametrically opposed to each other in the longitudinal vehicle direction, e.g., between a pair of measuring heads lying diametrically opposed in the longitudinal vehicle direction. If such a longitudinal connection exists on both sides of the motor vehicle, then changes in position may be detected at any time and also adjusted even when a motor vehicle is standing on the measuring station.

The present invention utilizes the fact that the measuring camera or the video sensors are provided with an LED illumination system, as shown in FIG. 2. During the measuring process, the perspective image, generated on the measuring cameras or on the image sensors of the measuring head, of the illumination devices of the measuring head lying on the opposite side in each case is used for monitoring or possibly correcting the common orientation.

The illumination device may be realized as pulsed flash light, so that the illumination is visible only during a very brief period of time. To enable the flash light to produce an image on the image sensor of a diametrically opposed measuring head, all illumination devices and image sensors or measuring cameras that are part of the measuring system must be synchronized with respect to each other.

As an alternative, the illumination device may also be realized as permanent light, so that continuous illumination is provided during the entire measurement. A synchronization of the illumination device and the measuring cameras in the measuring heads will not be necessary in this case.

As an alternative, the illumination is a pulsed flash light that is able to be switched into a permanent light mode. The illumination device is designed to allow switching between the modes of pulsed flash light and permanent light. This makes it possible, for instance, to switch into the permanent light mode for the control of the common orientation of the measuring heads in order to avoid the complex synchronization of all system components.

The following developments are conceivable, depending on the resolution of the measuring cameras and the quantity of light radiated by the illumination device during a particular period of time.

All elements of the illumination device constitute the feature to be monitored. If the resolution of the image camera is too low, or if the quantity of the light radiated by an illumination device is too high, then the individual elements of an illumination device such as the individual LEDs are no longer able to be separated, and the number of all individual elements of the illumination device is considered a single feature.

Individual elements of the illumination device constitute the feature to be monitored. If the resolution of the image camera is sufficient and the quantity of the light radiated by the illumination device not excessive, then the individual elements of an illumination device are perceivable separately from each other. Each individual element thus constitutes a separate feature. If the resolution of the camera is insufficient or the radiated light quantity excessive, it is also conceivable to illuminate the individual elements of an illumination device sequentially so that they are measurable despite the mentioned limitations.

The present invention is explained in greater detail below on the basis of exemplary embodiments with reference to the attached figures.

### BRIEF DESCRIPTION OF SEVERAL VIEWS OF DRAWINGS

FIG. 1 shows a schematic representation of the front measuring heads of a contactless chassis measuring system from the front.

FIG. 2 shows a schematic representation of the front left measuring head from the direction of the front right measuring head.

FIG. 3 shows a plan view of the two diametrically opposed measuring heads from FIG. 1, two positions being shown for the second measuring head.

FIG. 4 shows a schematic view of the two diametrically opposed measuring heads from FIG. 1, the second measuring head being shown in two positions, and the associated perspective image of the illumination devices of the second measuring head recorded by the upper stereo measuring camera.

### DETAILED DESCRIPTION OF THE INVENTION

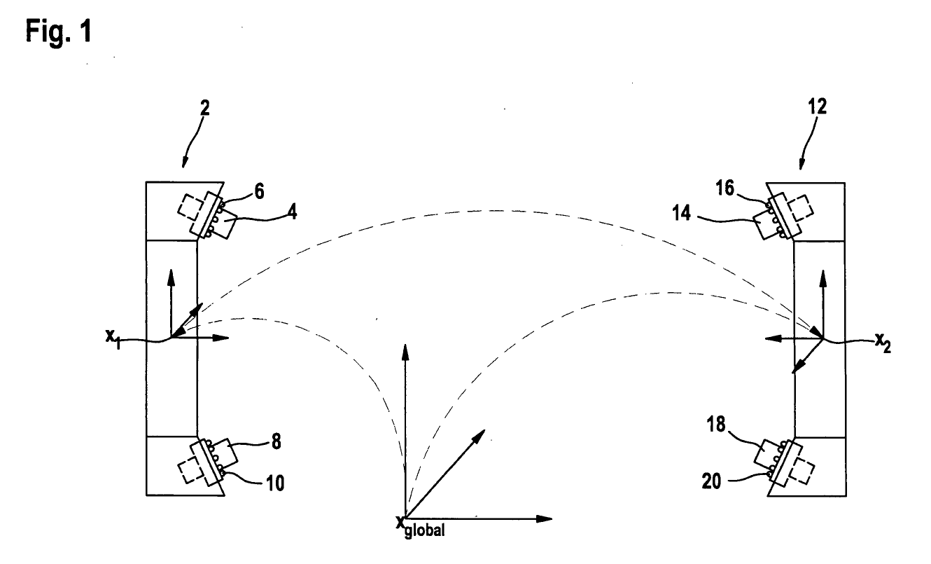

FIG. 1 shows a schematic illustration of front measuring heads 2 and 12 of a contactless chassis measuring systems, from the front.

In the contactless chassis measurement according to the present invention, four measuring heads are usually situated diametrically opposed to a wheel of a motor vehicle on a measuring station in each case. Of these measuring heads, FIG. 1 shows the two front measuring heads 2 and 12 from the front.

Lower stereo measuring cameras 8 and 18 are shown to be tilted slightly upward, and upper stereo cameras 4 and 14 are shown to be tilted slightly downward. Stereo measuring cameras 4, 8, 14 and 18 are each surrounded by a ring-shaped LED system 6, 10, 16 and 20, respectively. These ring-shaped LED systems 6, 10, 16 and 20 are used both for illuminating the wheel rim to be measured or the target to be measured mounted on the wheel rim, and also as target object for the diametrically opposed stereo measuring camera 4, 8, 14 and 18 for referencing measuring heads 2 and 12 with respect to each other. The implementation of the illumination devices as ring-shaped LED systems 6, 10, 16 and 20 is only an example. The illumination devices may also be developed as LED ring flash or in the form of Laser sources.

In this context, referencing refers to the process of determining the position parameters, that is, the alignment and the distances, of measuring heads 2 and 12 with respect to one another. The referencing requires the existence of a line of sight between measuring heads 2 and 12 situated across from each other in the transverse vehicle direction, i.e., that there is no motor vehicle on the measuring station or that no motor vehicle blocks the line of sight.

Measuring heads 4, 10, 16 and 22 are connected to a data processing unit (not shown in FIG. 1) either wirelessly or via connecting lines.

The chassis measuring system according to the present invention provides the advantage that it allows referencing of measuring heads 2 and 12 with respect to each other and that the illumination devices, which are provided for the measurement in the form of ring-shaped LED system 6, 10, 16 and 20 anyway may be utilized for this purpose, without the need to provide separate markings or ground control point elements at the measuring station for this purpose. This makes it possible to save costs.

Furthermore, in FIG. 1, X₁ denotes the local coordinate system of front left measuring head 2, X₂ denotes the local coordinate system of front right measuring head 12, and X_{global} denotes the global coordinate system. With the aid of the referencing according to the present invention, local coordinate systems X₁ and X₂ are transformed into global coordinate system X_{global}.

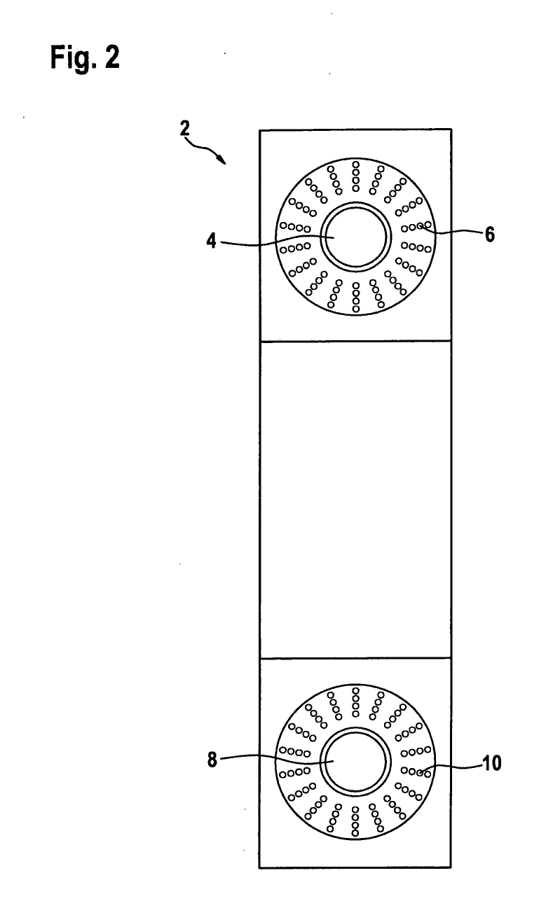

FIG. 2 shows a schematic representation of front left measuring head 2 from the direction of front right measuring head 12.

Ring-shaped LED systems 6 and 10 can be seen, which are situated around upper stereo measuring camera 4 and lower stereo measuring camera 8. In the exemplary embodiment, four concentric circles of LEDs each having 18 LEDs are disposed around measuring cameras 4 and 8 and form the individual illumination device.

In inclined placement of stereo measuring cameras 4, 8, 14, 18 having individual illumination devices 6, 10, 16 and 20, the lower stereo measuring cameras 8 and 18 monitor LED systems 16 and 6 lying on the opposite side, and upper measuring cameras 4 and 14 monitor LED systems 20 and 10 lying on the opposite side.

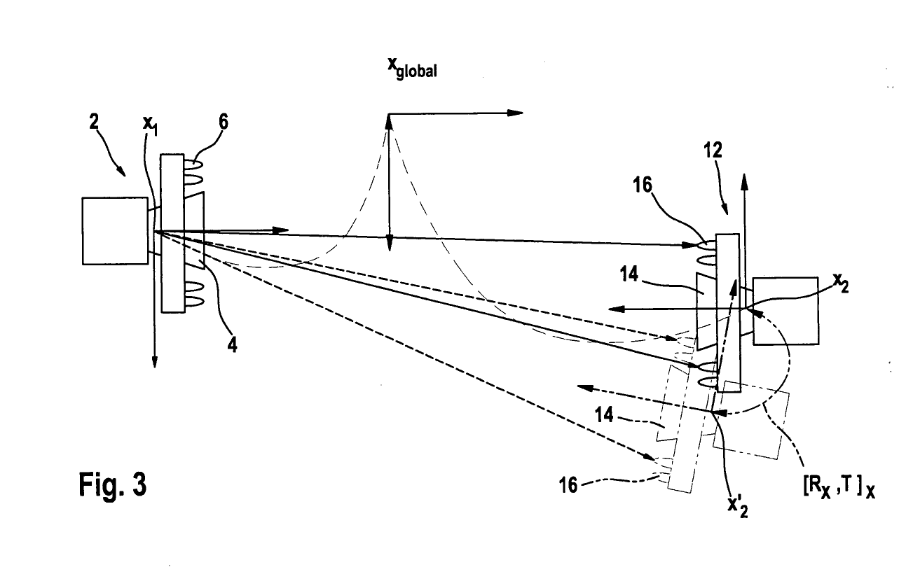

FIG. 3 shows a plan view of the two diametrically opposed measuring heads 2 and 12, two positions being shown for second measuring head 12.

To simplify matters, LED systems 6 and 16 are shown to the left and right of measuring camera 4 and 14, and it is assumed that upper measuring cameras 4 and 14 have opposite lying LED systems 16 and 6 in their fields of view.

FIG. 3 shows a first position in right measuring head 12, and a second position which is shifted in comparison with the first position and indicated by a dashed line. First local coordinate system X₁ may also be referred to as [R₁; T₁] and thereby as initial orientation of first measuring head 2 relative to global reference system X_{global}. In the first position of second measuring head 12, its local coordinate system X₂ represents the initial orientation of second measuring head 12 relative to global reference system [R₂; T₂]. R constitutes a rotation matrix, in particular a 3×3 rotation matrix, for describing the rotation, and T constitutes a translation vector for describing the translation between the coordinate systems.

The curved arrow shown as dashed line illustrates the shift in position of second measuring head 12 [R_{X}; T_{X}], from the initial position to the changed position. Two arrows shown as solid lines, which originate at first measuring camera 4 and lead to two LEDs of LED system 16 of second measuring head 12 selected by way of example, illustrate the initial monitoring of LED illumination system 16 by first measuring camera 4. Two arrows represented by dashed lines, which originate at first measuring camera 4 and lead to LEDs of second measuring head 12, represented by dashed lines, in the shifted position illustrate the monitoring of LED system 16 of second measuring head 12 in the shifted position.

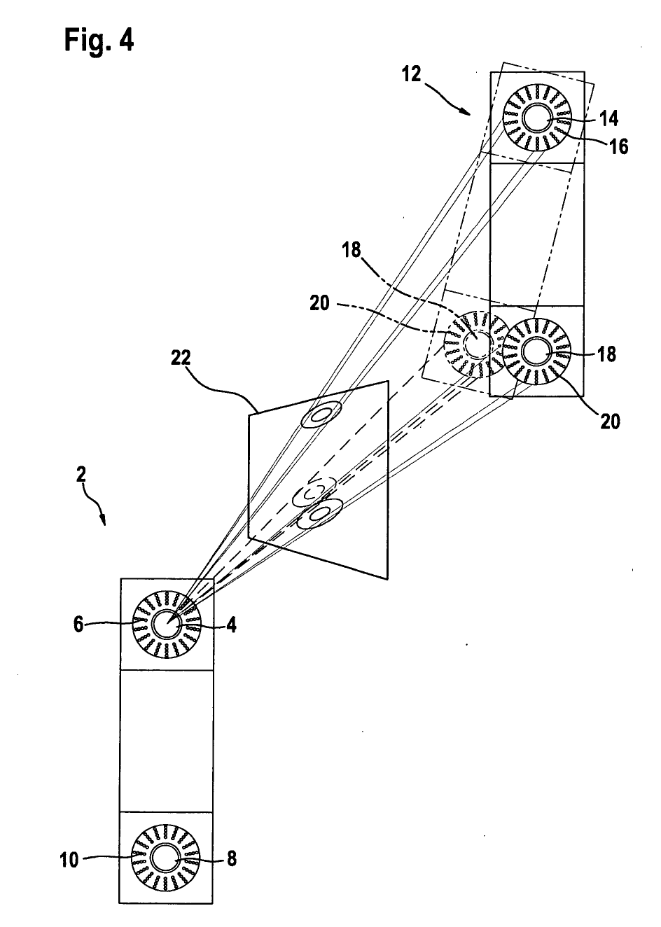

FIG. 4 shows a schematic view of two diametrically opposed measuring heads 2 and 12, second measuring head 12 being shown in two positions, and it shows the associated perspective image of illumination devices 16 and 20 of first measuring head 12 recorded by upper stereo measuring camera 4.

In FIG. 4, first measuring head 2 is shown as stationary, while second measuring head 12 is shown in a first position and in a position that differs from the first position and is indicated by a dashed line. The changed position relative to first position is shown rotated about upper stereo measuring camera 14. According to this, no shifting of first measuring camera 14 and upper LED system 16 has resulted from the first to the second position, but shifting of lower measuring camera 18 and lower LED system 20 did occur.

Shown halfway between the two measuring heads 2 and 12 is the perspective image of illumination devices 16 and 18 as it is recorded by upper measuring camera 4 of first measuring head 2. The upper darker ring and the lower darker ring represent the image of LED systems 16 and 18 in the first position of second measuring head 12. The upper darker ring and the middle ring, which is slightly lighter, represent the image of LED systems 16 and 18 in the second position of second measuring head 12.

The method according to the present invention for determining the position parameters of measuring heads 2 and 12 is briefly elucidated in the following text.

If the measuring heads have only a single camera in each case, the 2D-features of the illumination device lying opposite and being visible on the measuring camera are used for monitoring. The position of the features is tracked over time. If at any given time the instantaneous position deviates too much from the position of a preceding time period, then a warning, for example, is able to be output by the data processing unit of the chassis measuring system, to the effect that the orientation of the measuring heads with respect to each other has changed.

For the exemplary embodiment shown in FIGS. 1 through 4, in which measuring heads 2 and 12 have two measuring cameras 4 and 8 and 14 and 18, respectively, it is possible to calculate individual 3D positions from the 2-D features of the opposite-lying illumination devices 16, 20 and 6, 10 visible on measuring cameras 4, 8 and 14, 18. The two measuring cameras 4, 8 and 14, 18 of a measuring head 2 and 12 are calibrated with respect to each other.

The following algorithm indicated by way of example may be used to control and correct the position parameters, in particular the clearances and the orientations of measuring heads 2 and 12 relative to each other.

### 1. Initialization

1.1 Determining the D3-position, result: measuring heads 2 and 12 determine the 3D-positions of respective opposite lying illumination devices 6, 10 and 16, 20 in their individual local coordinate system.
1.2 Transformation of the measured points into the global coordinate system
   1.2.1 3D-position P_{LED1}_{_{—}}₂ of illumination devices 6, 10 of first measuring head 2 in coordinate system X₂ of second measuring head 12.

1.2.2 3D-position P_{LED2}_{_{—}}₁ of illumination devices 16, 20 of second measuring head 12 in coordinate system X₁ of first measuring head 2.

It should be pointed out that illumination devices 6, 10 and 16, 20 are fixedly joined to measuring heads 2, 12 and that their position relative to measuring head 2, 12 does not change in a movement of the measuring head.

### 2. Monitoring

2.1 For each recording instant, measuring heads 2, 12 determine the 3D-positions of visible illumination devices 16, 20 and 6, 10 of the opposite-lying measuring head 12, 2 in their local coordinate system. Then a transformation of the measured positions into the global coordinate system takes place.
2.2 Comparing the instantaneously measured positions with the initial position of illumination devices 6, 10 and 16, 20 determined in step 1.2.
   2.2.1 If no change in position has occurred, it is continued with step 2.1.
   2.2.2 If a change in position has occurred compared with the previous instants, as it is shown in FIGS. 3 and 4, step 3 follows.

### 3. Correction

3.1 Determining the position of illumination devices 6, 10 and 16, 20 in the global coordinate system according to step 2.1.
3.2 The positions of illumination devices 6, 10 and 16, 20 determined in step 3.1 are shifted relative to the initial position determined in step 1.2, by the orientation [R_{X}; T_{X}] caused by the change in position. For the correction, the orientation [R_{X}; T_{X}] is therefore able to be determined from the coordinate transformation between the scatter plots from steps 1.2 and 3.1, cf. FIGS. 3 and 4 in this regard.

If the measuring heads have more than two illumination devices, then the same algorithm may be used as explained above with reference to the measuring heads having two cameras in each case. The precision of the control and the correction is able to be improved by a better spatial distribution of the illumination devices. The method described above may also be used with a single camera, given a suitable spatial configuration of the illumination devices.

In addition to measuring axles, the method according to the present invention for determining the position parameters of measuring heads of a chassis measuring system is also suitable for additional applications in a chassis measurement, such as for checking the dynamic shock absorbers. In addition, the method according to the present invention may also called be a method for controlling the position of the measuring heads in a video-based axle-measuring system.

1-11. (canceled)

12. A chassis measuring system, comprising:
at least one pair of first and second measuring heads, which are situated diametrically opposed in the transverse vehicle direction, each measuring head having at least one measuring camera and an illumination device pointing in the same direction as the measuring camera, and
a data processing unit which is connected to the measuring heads and designed in such a way that it determines position parameters of the measuring heads relative to each other by comparing an image of the illumination device of the second measuring head recorded by the measuring camera of the first measuring head with stored reference images.

13. The chassis measuring system as recited in claim 12, wherein the illumination device is in the form of a ring around the measuring camera.

14. The chassis measuring system as recited in claim 12, wherein the illumination device is designed to generate pulsed flash light or continuous light.

15. The chassis measuring system as recited in claim 13, wherein the illumination device is designed to generate pulsed flash light or continuous light.

16. The chassis measuring system as recited in claim 12, wherein each measuring head including two measuring cameras pointing in the same direction.

17. The chassis measuring system as recited in claim 13, wherein each measuring head including two measuring cameras pointing in the same direction.

18. The chassis measuring system as recited in claim 14, wherein each measuring head including two measuring cameras pointing in the same direction.

19. The chassis measuring system as recited in claim 12, wherein at least one pair of first and second measuring heads are provided for the front wheels of the chassis and at least one pair of first and second measuring heads are provided for the rear wheels of the chassis, and the data processing unit is designed such that for each pair of measuring heads lying opposite one another in the transverse vehicle direction, position parameters of the measuring heads relative to each other are able to be determined from comparison of an image of the illumination device of the second measuring head recorded by the measuring camera of the first measuring head, with stored reference images.

20. The chassis measuring system as recited in claim 13, wherein at least one pair of first and second measuring heads are provided for the front wheels of the chassis and at least one pair of first and second measuring heads are provided for the rear wheels of the chassis, and the data processing unit is designed such that for each pair of measuring heads lying opposite one another in the transverse vehicle direction, position parameters of the measuring heads relative to each other are able to be determined from comparison of an image of the illumination device of the second measuring head recorded by the measuring camera of the first measuring head, with stored reference images.

21. The chassis measuring system as recited in claim 14, wherein at least one pair of first and second measuring heads are provided for the front wheels of the chassis and at least one pair of first and second measuring heads are provided for the rear wheels of the chassis, and the data processing unit is designed such that for each pair of measuring heads lying opposite one another in the transverse vehicle direction, position parameters of the measuring heads relative to each other are able to be determined from comparison of an image of the illumination device of the second measuring head recorded by the measuring camera of the first measuring head, with stored reference images.

22. The chassis measuring system as recited in claim 16, wherein at least one pair of first and second measuring heads are provided for the front wheels of the chassis and at least one pair of first and second measuring heads are provided for the rear wheels of the chassis, and the data processing unit is designed such that for each pair of measuring heads lying opposite one another in the transverse vehicle direction, position parameters of the measuring heads relative to each other are able to be determined from comparison of an image of the illumination device of the second measuring head recorded by the measuring camera of the first measuring head, with stored reference images.

23. A method for determining position parameters of measuring heads of a chassis measuring system as recited in claim 12, in which at least one pair of measuring heads lying diametrically opposed in the transverse vehicle direction is provided, comprising the following steps which are carried out for each pair of first and second measuring heads:
operating the illumination device of the second measuring head and recording an image of the same by the measuring camera of the first measuring head;
determining position parameters of the illumination device of the second measuring head in the local coordinate system of the first measuring head by comparing the recorded image with stored reference images; and
transforming the position parameters of the illumination device of the second measuring head into a global coordinate system.

24. The method as recited in claim 23, wherein the following steps are performed for each pair of first and second measuring heads:
operating the illumination device of the first measuring head and recording an image of the same by the measuring camera of the second measuring head;
determining position parameters of the illumination device of the first measuring head in the local coordinate system of the second measuring head by comparing the recorded image with stored reference images; and
transforming the position parameters of the illumination device of the first measuring head into a global coordinate system.

25. The method as recited in claim 23, further comprising the following steps:
repeating the steps of operating, determining and transforming;
checking whether the position parameters have changed; and
correcting the position parameters using a coordinate transformation of the previously determined position parameters in the global coordinate system, to the instantaneous position parameters in the global coordinate system.

26. The method as recited in claim 24, further comprising the following steps:
repeating the steps of operating, determining and transforming;
checking whether the position parameters have changed; and
correcting the position parameters using a coordinate transformation of the previously determined position parameters in the global coordinate system, to the instantaneous position parameters in the global coordinate system.

27. The method as recited in claim 23, wherein the illumination device is viewed as shared feature in the image of the illumination device and compared to a reference image.

28. The method as recited in claim 24, wherein the illumination device is viewed as shared feature in the image of the illumination device and compared to a reference image.

29. The method as recited in claim 23, wherein individual elements of the illumination device are viewed as separate features in the image of the illumination device and are compared to a corresponding reference image.

30. The method as recited in claim 24, wherein individual elements of the illumination device are viewed as separate features in the image of the illumination device and are compared to a corresponding reference image.

31. The method as recited in claim 23, wherein the illumination device is operated using pulsed flash light during the image recording, and the measuring camera and the illumination device are synchronized.
